(19) United States
(12) Patent Application Publication
(10) Pub. No.: US 2002/0198133 A1
(43) Pub. Date: Dec. 26, 2002

(54) Solid surfactant compositions, their preparation and use

(76) Inventors: Ansgar Behler, Bottrop (DE); Karl Heinz Schmid, Mettmann (DE); Detlev Stanislowski, Mettmann (DE); Andreas Syldath, Monheim (DE); Manfred Weuthen, Langenfeld (DE)

Correspondence Address: COGNIS CORPORATION, 2500 RENAISSANCE BLVD., SUITE 200, GULPH MILLS, PA, 19406

(21) Appl. No.: 10/128,749

(22) Filed: Apr. 23, 2002

(30) Foreign Application Priority Data
Apr. 25, 2001 (DE) 101 20 263.6

(51) Int. Cl. C11D 17/00

(52) U.S. Cl. 510/466

(57) ABSTRACT

Surfactant mixtures in solid form which have a core and a shell, where the core comprises at least one nonionic surfactant, are proposed.

The invention relates to the field of laundry detergents, in particular novel coated surfactant compositions for use in laundry detergents, in particular in laundry detergent compacts.

### PRIOR ART

Laundry detergents and cleaners usually comprise a mixture of different surfactants, a proportion of nonionic surfactants generally being present in such a surfactant mixture. Such nonionic surfactants are usually in the form of liquids of varying viscosity or solids. With a few exceptions, the last-mentioned solid nonionic surfactants usually have a sticky surface.

Because of these facts, the incorporation of nonionic surfactants into washing- or cleaning-active preparations has hitherto been burdened with various problems. To prepare customary pulverulent laundry detergents or cleaners, the nonionic surfactants have usually, within the scope of the spray-drying process in a spray tower, been sprayed onto the spray-tower powder. Alternatively, it has also been possible to apply nonionic surfactants to a laundry detergent powder by other methods customarily used for applying liquid compounds to solids, for example by nozzle introduction in a moving bed.

However, this procedure is disadvantageous for various reasons. Thus, for example, the corresponding nonionic surfactant or a mixture of two or more nonionic surfactants must always be in liquid form. Particularly in the case of nonionic surfactants with a relatively high molecular weight, this is associated with the fact that a corresponding solution of the nonionic surfactant must be prepared before it can be applied to a powder within the scope of one of the processes described. Moreover, the handling of the nonionic surfactants is involved in view of an economic preparation of laundry detergents and cleaners.

The processes known from the prior art and the products obtainable thereby, moreover, have further disadvantages.

Thus, for example, the consumer often demands laundry detergent or cleaner compacts which are usually to be present in extrudate, granulate or tablet form. However, if such compacts are prepared from the abovementioned powders, then the nonionic surfactants present therein are not integrated into the compact in a fixed place, but tend to migrate. In this connection, the nonionic surfactants migrate, for example, to the surfaces of the compacts. However, such compacts which comprise nonionic surfactants on the surface have a tendency for caking. This does, however, have a disadvantageous effect on the decomposition rate of compacts which comprise such migrating nonionic surfactants.

In addition, such nonionic surfactants which are present on the surface in the compacts may penetrate a corresponding packaging material for the compacts, which may lead to ugly stains on the packaging material. Moreover, such nonionic surfactants are permanently withdrawn from the compact, as a result of which the washing or cleaning power is reduced.

On several occasions, attempts have also been made according to the prior art to make surfactant compositions which are sticky on the surface nonsticky by dusting with inorganic salts. However, a problem with processes of this type is that the abrasion resistance of such powdered granulates leaves little to be desired, as a result of which an undesired fine dust often forms following storage and transportation of such surfactant compositions.

There was therefore a need for surfactant compositions which do not have the abovementioned disadvantages of the surfactant compositions known from the prior art. In particular, there was a need for compositions which comprise a nonionic surfactant or a mixture of two or more nonionic surfactants, where such compositions are suitable for use in laundry detergents or cleaners, in particular in laundry detergent or cleaner compacts, and such compacts do not have the abovementioned disadvantages known from the prior art. Moreover, there was a need for surfactant compositions which comprise at least one nonionic surfactant or a mixture of two or more nonionic surfactants, where such a surfactant composition is suitable for use in a very wide variety of laundry detergents or cleaners and is in powder form, where the powder is free-flowing and does not have a tendency toward caking even in unfavorable storage conditions.

The object of the present invention is therefore to provide such surfactant compositions.

The objects on which the invention is based are achieved by a composition, and also a process for preparation thereof, as are described in the text below.

### DESCRIPTION OF THE INVENTION

The invention therefore provides surfactant mixtures in solid form which have a core and a shell, where the core comprises at least one nonionic surfactant and the shell comprises, as coating substance, at least one anionic surfactant or at least one nonionic surfactant which is not present in the core or at least one zwitterionic surfactant or a mixture of two or more of said surfactants.

Nonionic surfactants

The nonionic surfactants used are preferably alkoxylated, advantageously ethoxylated, in particular primary alcohols having, preferably, 8 to 18 carbon atoms and on average 1 to 50, in particular 2 to about 30 or 3 to about 15, mol of ethylene oxide (EO) per mole of alcohol, in which the alcohol radical may be linear or preferably methyl-branched in the 2 position or can contain a mixture of linear and methyl-branched radicals, as are usually present in oxo alcohol radicals. In particular, however, preference is given to alcohol ethoxylates with linear radicals from alcohols of native origin having 12 to 18 carbon atoms, e.g. from coconut alcohol, palm alcohol, tallow fat alcohol or oleyl alcohol, and on average 2 to 8 EO per mole of alcohol. Preferred ethoxylated alcohols include, for example, C₁₂₋₁₄-alcohols with 3 EO or 4 EO, C₉₋₁₁-alcohol with 7 EO, C₁₃₋₁₅-alcohols with 3 EO, 5 EO, 7 EO or 8 EO, C₁₂₋₁₈-alcohols with 3 EO, 5 EO or 7 EO and mixtures thereof, and mixtures of C₁₂₋₁₄-alcohol with 3 EO and C₁₂₋₁₈-alcohol with 5 EO. The given degrees of ethoxylation represent statistical average values which may be an integer or a fraction for a specific product. Preferred alcohol ethoxylates have a narrowed homolog distribution (narrow range ethoxylates, NRE). In addition to these nonionic surfactants, it is also possible to use fatty alcohols with more than 12 EO. Examples thereof are coconut alcohol with 14 EO, 25 EO, 30 EO or 40 EO.

A further class of preferred nonionic surfactants, which are either used as the sole nonionic surfactant or in combination with other nonionic surfactants as a constituent of the core of the surfactant compositions according to the invention, are alkoxylated, preferably ethoxylated or ethoxylated and propoxylated fatty acid alkyl esters, preferably having 1 to 4 carbon atoms in the alkyl chain, in particular fatty acid methyl esters, as described, for example, in Japanese patent application JP 58/217598 or which are preferably prepared by the process described in international patent application WO-A-90/13533.

A further class of nonionic surfactants which can be used advantageously is the alkyl polyglycosides (APG). Alkyl polyglycosides which can be used satisfy the general formula RO(G)_{z}, in which R is a linear or branched, in particular methyl-branched in the 2 position, saturated or unsaturated, aliphatic radical having 8 to 22, preferably 12 to 18, carbon atoms and G is the symbol which stands for a glycose unit having 5 or 6 carbon atoms, preferably glucose. The degree of glycosylation z is here between 1.0 and 4.0, preferably between 1.0 and 2.0 and in particular between 0.1 and 1.4.

Preference is given to using linear alkyl polyglucosides, i.e. alkyl polyglycosides in which the polyglycosyl radical is a glucose radical and the alkyl radical is an n-alkyl radical.

The surfactant compositions according to the invention can preferably comprise alkyl polyglycosides, where contents of APG in the surfactant compositions of more than 0.2% by weight, based on the total surfactant composition, are preferred. Surfactant compositions which are suitable according to the invention comprise APG in amounts of from 0.2 to 10% by weight, preferably in amounts of from 0.2 to 5% by weight and in particular in amounts of from 0.5 to 3% by weight.

Nonionic surfactants of the amine oxide type, for example N-cocoalkyl-N,N-dimethylamine oxide and N-tallow-alkyl-N,N-dihydroxyethylamine oxide, and of the fatty acid alkanolamide type are also suitable for the purposes of the present invention as a constituent of the surfactant compositions according to the invention. The amount of these nonionic surfactants is preferably not more than the amount of the ethoxylated fatty alcohols present in a surfactant composition according to the invention, in particular is not more than half thereof.

Further suitable nonionic surfactants are polyhydroxy fatty acid amides of the formula (I),

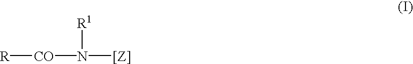

in which RCO is an aliphatic acyl radical having 6 to 22 carbon atoms, R¹ is hydrogen, an alkyl or hydroxyalkyl radical having 1 to 4 carbon atoms and [Z] is a linear or branched polyhydroxyalkyl radical having 3 to 10 carbon atoms and 3 to 10 hydroxyl groups. The polyhydroxy fatty acid amides are known substances which can usually be obtained by reductive amination of a reducing sugar with ammonia, an alkylamine or an alkanolamine and subsequent acylation with a fatty acid, a fatty acid alkyl ester or a fatty acid chloride.

The group of polyhydroxy fatty acid amides also includes compounds of the formula (II),

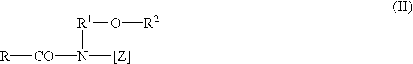

in which R is a linear or branched alkyl or alkenyl radical having 7 to 12 carbon atoms, R¹ is a linear, branched or cyclic alkyl radical or an aryl radical having 2 to 8 carbon atoms and R² is a linear, branched or cyclic alkyl radical or an aryl radical or an oxy-alkyl radical having 1 to 8 carbon atoms, where C₁₋₄-alkyl or phenyl radicals are preferred and [Z] is a linear polyhydroxyalkyl radical whose alkyl chain has been substituted by at least two hydroxyl groups, or alkoxylated, preferably ethoxylated or propoxylated derivatives of this radical.

[Z] is preferably obtained by reductive amination of a reducing sugar, for example glucose, fructose, maltose, lactose, galactose, mannose or xylose. The N-alkoxy or N-aryloxy-substituted compounds can then be converted, for example in accordance with the teaching of international application WO-A-95/07331, into the desired polyhydroxy fatty acid amides by reaction with fatty acid methyl esters in the presence of an alkoxide as catalyst.

For the purposes of the present invention, both liquid and solid nonionic surfactants are suitable as core of the surfactant compositions according to the invention. If a surfactant composition according to the invention comprises, as core, a mixture of two or more nonionic surfactants, then a mixture of such nonionic surfactants can, for example, have a composition such that it comprises both solid and liquid nonionic surfactants, but overall has an essentially solid aggregate state. According to the invention, however, it is likewise provided that a surfactant composition according to the invention comprises exclusively liquid surfactants in the core. In such cases it is necessary for the liquid surfactants in the surfactant compositions according to the invention to be applied to a carrier material.

Suitable carrier materials are all known inorganic and/or organic carrier materials. Examples of typical inorganic carrier materials are alkali metal carbonates, alumosilicates, water-soluble phyllosilicates, alkali metal silicates, alkali metal sulfates, for example sodium sulfate, and alkali metal phosphates. The alkali metal silicates are preferably a compound with a molar ratio of alkali metal oxide to SiO₂ of 1:1.5 to 1:3.5. The use of such silicates results in particularly good particle properties with high dissolution rate in water. The alumosilicates referred to as carrier material include, in particular, the zeolites, for example zeolite NaA and NaX.

The compounds referred to as water-soluble phyllosilicates include, for example, amorphous or crystalline waterglass. It is also possible to use silicates which are available commercially under the name Aerosil® or Sipemat®.

Suitable organic carrier materials are, for example, polymers, such as polyvinyl alcohols, polyvinylpyrrolidones, poly(meth)acrylates, polycarboxylates, cellulose derivatives, such as cellulose ethers and starch. Suitable cellulose ethers are, in particular, alkali metal carboxymethylcellulose, methylcellulose, ethylcellulose, hydroxyethylcellulose and so-called cellulose mixed ethers, such as, for example, methylhydroxyethylcellulose and methylhydroxypropylcellulose, and mixtures of two or more thereof. Particularly suitable mixtures comprise, for example, sodium carboxymethylcellulose and methylcellulose, where the carboxymethylcellulose usually has a degree of substitution of from 0.5 to 0.8 carboxymethyl groups per anhydroglucose unit and the methylcellulose has a degree of substitution of from 1.2 to 2 methyl groups per anhydroglucose unit.

The mixtures preferably comprise alkali metal carboxymethylcellulose and nonionic cellulose ethers in weight ratios of from 80:20 to 40:60, in particular from 75:25 to 50:50.

Another suitable carrier is native starch, which is built up from amylose and amylopectin. Native starch is the term used for starch as is obtainable as extract from natural sources, for example from rice, potatoes, corn and wheat. Native starch is a standard commercial product and is thus readily available. Carrier materials which can be used are just one or two or more of the abovementioned compounds, in particular chosen from the group of alkali metal carbonates, alkali metal sulfates, alkali metal phosphates, zeolites, water-soluble phyllosilicates, alkali metal silicates, polycarboxylates, cellulose ethers, polyacrylate/polymethacrylate and starch. Particularly suitable mixtures are those of alkali metal carbonates, in particular sodium carbonate, alkali metal silicates, in particular sodium silicate, alkali metal sulfates, in particular sodium sulfate and zeolites.

If the core of a surfactant composition according to the invention comprises a nonionic surfactant that exhibits a pH-dependent stability, then the carrier material should preferably be chosen such that the stability of a corresponding nonionic compound present in the core of a surfactant composition according to the invention is not impaired. Thus, particularly when the core of a surfactant composition according to the invention comprises a fatty acid alkyl ester as nonionic surfactant, a carrier material should be chosen which ensures the stability of such a compound. In this connection, particularly suitable carrier materials are compounds which have an essentially neutral or acidic pH. Carrier materials which are particularly suitable for such nonionic surfactants, in particular for fatty acid methyl ester ethoxylates are, for example, zeolites, sodium sulfate, polyacrylates, cellulose, microcrystalline cellulose, carboxymethylcellulose, methylcellulose or starch.

Depending on the aggregate state of the surfactant, or a mixture of two or more surfactants, present in the core of a surfactant composition according to the invention, the proportion of nonionic surfactant or nonionic surfactants in the core can be up to 100% by weight. If the core of a surfactant composition according to the invention comprises a carrier material, then the ratio of carrier material to nonionic surfactant is preferably about 10:90 to about 90:10, for example about 20:80 to about 80:20 or about 30:70 to about 60:40.

Within the scope of a further embodiment of the present invention, a surfactant composition according to the invention can comprise, in the core, in addition to a nonionic surfactant or a mixture of two or more nonionic surfactants and optionally a carrier material, also one or more further compounds. Suitable as constituent of the core of the of the surfactant compositions according to the invention are, for example, anionic surfactants as mentioned in the text below.

If a surfactant composition according to the invention comprises an anionic surfactant or a mixture of two or more anionic surfactants in the core, then the ratio of nonionic surfactants to anionic surfactants is preferably about 2:98 to about 50:50 or about 5:95 to about 30:70 if the nonionic surfactant is a product which is liquid at a maximum of about 30° C. If, on the other hand, the nonionic surfactant has a melting point or melting range of more than about 30° C., in particular more than about 40° C., then the ratio of nonionic surfactants to anionic surfactants is preferably about 2:98 to about 90:10 or about 5:95 to about 70:30.

Coating substances

As well as a core, as has already been described within the scope of the present text, a surfactant composition according to the invention also has a shell. A shell suitable for the purposes of the present invention has one or more coating substances.

Within the scope of a preferred embodiment of the present invention, the coating substances used are surfactants chosen from the group consisting of olefinsulfonates, ester sulfonates, sulfates based on linear (fatty alcohols and Ziegler alcohols) or branched alcohols (oxo alcohols), alkanesulfonates, fatty acid monoglyceride sulfates, betaines, alkyl polyglycosides, isethionates, sarcosides, taurates, fatty alcohol ethoxylates with up to 40 EO units, fatty acid ester ethoxylates having 1 to 5 EO units, polyethylene glycols with a molecular weight of more than about 2 000, fatty acid ethyleneglycol esters, acyl lactylates, alkyl oligoglucoside sulfates, protein fatty acid condensates (in particular vegetable products based on soya), alkyl (ether) phosphates and acylated amino acids such as acyl glutamate, or mixtures of two or more thereof.

The abovementioned compounds which can be used as coating substances can here, for the purposes of the present invention, be used individually or as a mixture of two or more substances of in each case one or more of said classes of substance. In a preferred embodiment of the present invention, the coating substances used are compounds which have a crystalline or amorphous structure. The shell of the surfactant compositions according to the invention preferably comprises surfactants which have a nonsticky surface at room temperature or in a range of up to about 60° C. or about 50° C.

The shell of a surfactant composition according to the invention can here also have surfactants which have a pasty or sticky consistency in the abovementioned temperature range. The proportion of such surfactants in the entire shell must here, however, be such that the shell of the surfactant composition according to the invention is not pasty or sticky overall.

The shell of a surfactant composition according to the invention can be constructed from one layer or from two or more layers. If the shell is constructed from one layer, then the coating substances should be chosen so that the abovementioned requirements with regard to the stickiness of the outer shell are satisfied. If, however, for example the shell of a surfactant composition according to the invention has a stickiness which does not lead to the aim with regard to the present invention, then a further layer can, for example, be applied to such a layer, this further layer regulating the consistency of the shell such that the requirements according to the invention are satisfied. With regard to the composition of the individual layers of such a shell consisting of two or more layers, it is exclusively necessary that the composition of the layers forming the shell satisfies overall the abovementioned requirements for the ingredients of the shell.

For the purposes of the present invention, then, a surfactant composition according to the invention is referred to as nonsticky if it remains essentially flowable after a storage time of 1 week at a temperature of at least about 20° C. to about 40° C. in a standard commercial big-bag, i.e. the big-bag can be emptied without clumping.

In a first embodiment of the present invention, the surfactant compositions according to the invention comprise at least one anionic surfactant as coating substance.

Suitable anionic surfactants for the purposes of the present invention are, in principle, all anionic surfactants. In a preferred embodiment of the present invention, at least one anionic surfactant used as coating substance originates from the group of sulfates or sulfonates.

Surfactants of the sulfonate type are here preferably C₈₋₁₈-alkylbenzenesulfonates, in particular C₁₂₋₁₈-olefin-sulfonates, i.e. mixtures of alkene- and hydroxyalkane-sulfonates, and disulfonates, as are obtained, for example, from C₈₋₁₈-monoolefins with a terminal or internal double bond by sulfonation with gaseous sulfur trioxide and subsequent alkaline or acidic hydrolysis of the sulfonation products. Also suitable are alkanesulfonates which are obtained from C₁₂₋₁₈-alkanes, for example by sulfochlorination or sulfoxidation with subsequent hydrolysis or neutralization. Also suitable are the esters of 2-sulfo fatty acids (ester sulfonates), e.g. the 2-sulfonated methyl esters of hydrogenated coconut, palm kernel or tallow fatty acids.

Further suitable anionic surfactants are sulfated fatty acid glycerol esters. Fatty acid glycerol esters are to be understood as meaning the mono-, di- and triesters, and mixtures thereof, as are obtained in the preparation by esterification of a monoglycerol with 1 to 3 mol of fatty acid or in the transesterification of triglycerides with 0.3 to 2 mol of glycerol. Preferred sulfated fatty acid glycerol esters are here sulfation products of saturated fatty acids having 6 to 22 carbon atoms, for example of caproic acid, caprylic acid, capric acid, myristic acid, lauric acid, palmitic acid, stearic acid or behenic acid.

Preferred alk(en)yl sulfates are the alkali metal, and in particular the sodium, salts of sulfuric monoesters of C₈-C₁₈-fatty alcohols, for example C₁₂-C₁₆-fatty alcohols, for example of coconut fatty alcohol, tallow fatty alcohol, lauryl alcohol, myristyl alcohol, cetyl alcohol or stearyl alcohol or of C₁₀-C₂₀-oxo alcohols and those monoesters of secondary alcohols of these chain lengths. Also preferred are alk(en)yl sulfates of said chain length which contain a synthetic straight-chain alkyl radical prepared on a petrochemical basis, which have an analogous degradation behavior to the equivalent compounds based on fatty chemical raw materials. For the purposes of the present invention, the C₁₂-C₁₆-alkyl sulfates and C₁₂-C₁₄-alkyl sulfates, and C₁₄-C₁₅-alkyl sulfates are preferred. 2,3-Alkyl sulfates, which are prepared, for example, according to U.S. Pat. Nos. 3,234,258 or 5,075,041 and can be obtained as commercial products from the Shell Oil Company under the name DAN® are also suitable anionic surfactants.

The sulfuric monoesters of the straight-chain or branched C₇₋₂₁-alcohols ethoxylated with 1 to 6 mol of ethylene oxide, such as 2-methyl-branched C₉₋₁₁-alcohols with, on average, 3.5 mol of ethylene oxide (EO) or C₁₂₋₁₈-fatty alcohols with 1 to 4 EO, are also suitable.

Further suitable anionic surfactants for the purposes of the present invention are also the salts of alkylsulfosuccinic acid, which are also referred to as sulfosuccinates or as sulfosuccinic esters, and which represent monoesters and/or diesters of sulfosuccinic acid with alcohols, preferably fatty alcohols and in particular ethoxylated fatty alcohols. Preferred sulfosuccinates contain C₈₋₁₈-fatty alcohol radicals or mixtures thereof. Particularly preferred sulfosuccinates contain a fatty alcohol radical derived from ethoxylated fatty alcohols which, when viewed per se, represent nonionic surfactants (for description see below). Here, sulfosuccinates whose fatty alcohol radicals are derived from ethoxylated fatty alcohols with narrowed homolog distribution are again particularly preferred. It is likewise also possible to use alk(en)ylsuccinic acid having preferably 8 to 18 carbon atoms in the alk(en)yl chain or salts thereof.

If the core of a surfactant composition according to the invention comprises a nonionic surfactant that exhibits pH-dependent stability, then the shell should preferably be constructed in such a way that the stability of a corresponding nonionic compound present in the core of a surfactant composition according to the invention is not impaired. For example, particularly when the core of a surfactant composition according to the invention comprises a fatty acid alkyl ester as nonionic surfactant, a coating material should be chosen which ensures the stability of such a compound. Particularly suitable coating materials here are anionic surfactants which are present in a form which ensures an essentially neutral or acidic pH. Coating materials which are particularly suitable for such nonionic surfactants, in particular for fatty acid methyl ester ethoxylates are, for example, neutral pastes of anionic surfactants, in particular a neutral fatty alcohol sulfate paste. Such a neutral fatty alcohol sulfate paste is obtained, for example, by neutralizing a fatty alcohol sulfate paste present after a sulfation with a pH of about 9-10 to a pH of about 6-7 by stirring in a 50% strength aqueous solution of citric acid.

In a further embodiment of the present invention, a surfactant composition according to the invention can comprise, as single coating substance or as constituent of a mixture of two or more coating substances, a nonionic surfactant. Nonionic surfactants suitable as coating substances [lacuna] solid nonionic surfactants which have a nonsticky surface. However, it is also possible, for the purposes of the present invention, to use nonionic surfactants which are liquid or have a sticky surface as coating substances. In this case, such nonionic surfactants must, however, be present in a mixture with at least a second coating substance such that the shell has a nonsticky surface overall. In principle, suitable coating substances are all nonionic surfactants which have already been listed within the scope of the present text provided they, alone or in a mixture with one or more further coating substances, provide a nonsticky surface.

Depending on the desired use of the laundry detergent additives according to the invention, the weight ratio of shell to core can vary in a wide range. Examples of suitable weight ratios of shell to core are from about 10:1 to about 1:100 or about 5:1 to about 1:50. In a preferred embodiment of the present invention, the weight proportion of the shell of the overall surfactant composition according to the invention should be about 1 to about 30% by weight, for example about 2 to about 20 or about 5 to about 10% by weight. The weight ratio of anionic surfactants in the shell to nonionic surfactants in the core of a surfactant composition according to the invention should, in a preferred embodiment of the present invention, be about 90:10 to about 10:90 or about 20:80.

The coating substances are preferably water-soluble compounds which more preferably have a solubility in water at 20° C. of at least 0.1 g/l, preferably at least 1 g/l and in particular at least about 10 g/l.

In a further embodiment of the present invention, the shell of a surfactant composition according to the invention can, in addition to one or more of the abovementioned compounds, also comprise a further coating substance or a mixture of two or more further coating substances.

These further coating substances are preferably water-soluble compounds which more preferably have a solubility in water at 20° C. of at least 1 g/l, preferably at least 5 g/l and in particular at least 10 g/l and advantageously have further useful properties for the use of a surfactant composition according to the invention in laundry detergents or cleaners, for example the complexing of hardness formers and heavy metal ions. Alternatively, instead of the water-soluble compounds, meltable compounds are in principle also suitable.

In a preferred embodiment, the further coating substances are used in particular as a constituent of the shell of a laundry detergent additive according to the invention when the hardness, abrasion resistance or water solubility of the shell is to be set at a certain value and this value cannot be achieved using the abovementioned coating substances.

In a first embodiment of the invention, the substances may be salts of inorganic mineral acids. Typical examples are the alkali metal and/or alkaline earth metal salts, aluminum or zinc salts of hydrochloric acid, sulfuric acid, nitric acid, phosphoric acid, boric acid and silicic acid, in which case particular mention should be made of the alkali metal sulfate, alkali metal borates and perborates, the various alkali metal silicates (“waterglasses”) and alkali metal phosphates. Typical examples are sodium sulfate heptahydrate or borax.

Suitable salts are also the salts of organic carboxylic acids. Typical examples are the alkali metal and/or alkaline earth metal salts, aluminum or zinc salts of monocarboxylic acids having 1 to 22 carbon atoms, for example acetic acid, caproic acid, caprylic acid, 2-ethylhexanoic acid or coconut fatty acid or mixtures of two or more thereof. Particular preference is given to the use of sodium acetate.

Instead of the monocarboxylic acids it is also possible to use corresponding C₂-C₆-dicarboxylic acids, meaning that suitable further coating substances are, in an identical manner to above, also the corresponding salts of succinic acid, maleic acid, fumaric acid, glutaric acid and adipic acid.

Finally, it is also possible to use salts of hydroxy-functionalized polyhydric carboxylic acids, such as, for example, the abovementioned salts of malic acid, tartaric acid and in particular citric acid. In this connection, the use of alkali metal citrates is very particularly preferred.

A third group of suitable further coating substances which may be mentioned are the water-soluble polymers, which may, for example, be protein hydrolysates, polyamides, polycarboxylates and polyurethanes. Urea and polyurea are also suitable. Also suitable are saccharides and polysaccharides, such as, for example, sucrose, maltose or starch hydrolysates. Particular preference is given in this connection to the polycarboxylates, for example copolymers of acrylate/methacrylate, copolymers of acrylate/maleate (e.g. Sokalan CP 5, manufacturer: BASF), or polyaspartate.

In a further preferred embodiment of the present invention, the shell of a laundry detergent additive according to the invention has, as further coating substance, at least one water-soluble polymer. Water-soluble polymers are especially suitable as constituent of the shell of a detergent additive according to the invention when parameters such as hardness, abrasion resistance or solubility in water are to be influenced. The proportion of such a water-soluble polymer is, depending on the desired properties of the shell, about 0 to about 50% by weight, based on the total coating substance, in particular about 1 to about 30% by weight, for example about 5 to about 25% by weight.

Preparation processes

The surfactant compositions according to the invention can be prepared by processes which are already known for the production of laundry detergents. In a first preparation process, a surfactant core is firstly prepared which is then brought into contact with an aqueous solution of the coating substance.

The preparation of a corresponding surfactant core is likewise carried out in this connection in accordance with processes which are known in principle. If the anionic surfactant, or the mixture of two or more anionic surfactants, present in the core is a solid, then a corresponding surfactant core can, for example, be produced by grinding the surfactant or surfactant mixture to a desired size. If the anionic surfactant, or the mixture of two or more anionic surfactants, present in the core is a liquid, then the preparation of a correspondingly suitable surfactant core is carried out, for example, by applying the liquid surfactant or surfactant mixture, for example from a suitable solution, to a carrier material which is in pulverulent or granular form with simultaneous drying, e.g. in a moving-bed process or in a fluidized-bed process. Such processes can, for example, be carried out in customary mixing apparatuses.

A surfactant core prepared in this way is then brought into contact, in a second process step, with a solution of a coating substance or a mixture of two or more coating substances. This is preferably carried out at relatively high temperatures, the coating substance precipitating onto the surfactant core and enclosing it in the process.

A particularly preferred possibility consists in subjecting the surfactant cores to a fluidized-bed granulation. This is to be understood as meaning a granulation with simultaneous drying, which is preferably carried out batchwise or continuously. The aqueous solutions of the coating substances are introduced into a fluidized bed with surfactant cores simultaneously or one after the other via one or more nozzles. Preferably, surfactant cores are continuously blown in via one nozzle and the coating substances are metered in via a second nozzle. This corresponds to a continuous solid/liquid preparation, but requires that corresponding surfactant cores are already present. The SKET process e.g. from Glatt und Haase is particularly suitable for this purpose. Here, the resulting granulate is divided simultaneously into size fractions, where, for the purposes of the present invention, an acceptable particle fraction in the range from about 0.1 to about 1.5 mm, in particular about 0.2 to about 1.2 mm is preferably separated off, as is a fines fraction (for example <0.1 mm, preferably <0.2 mm) and a coarse fraction (for example >1.5 mm, preferably >1.2 mm). The coarse fraction is, for example, ground and returned to the SKET process again together with the fines fraction.

Preferred fluidized bed apparatuses have base plates with dimensions of from 0.4 to 5 m. The granulation is preferably carried out at fluidized-air speeds in the range from 1 to 8 m/s. The granulates are discharged from the fluidized bed preferably via a size classification of the granulates. Classification can take place, for example, by means of a sieve device or through a countercurrent stream of air (sifter air) which is regulated such that only particles above a certain particle size are removed from the fluidized bed and smaller particles are retained in the fluidized bed. The air which flows in is usually composed of the heated or unheated sifter air and the heated base air. The base air temperature is here between 80 and 400° C., preferably between 90 and 350° C.

Industrial applicability

The present invention further relates to the use of the surfactant compositions according to the invention for the preparation of detergents, preferably in detergents which are in the form of powders, granulates, extrudates in or tablets. The present invention thus also relates to detergents which have a content of surfactant compositions according to the invention.

Further preferred ingredients of such detergents which are obtainable using the surfactant compositions according to the invention are inorganic and organic builder substances, the inorganic builder substances used mainly being zeolites, crystalline phyllosilicates and amorphous silicates with builder properties and—where permissible—also phosphates, for example tripolyphosphates. The builder substances are preferably present in the detergents according to the invention in amounts of from about 10 to about 60% by weight, based on the total detergent. If these compounds are soluble in water, they can, for example, also be used as further coating substances in the above sense in the laundry detergent additives according to the invention. This applies equally to the silicates, dextrins, polyacrylates and the like described below.

The no crystalline synthetic, bonded-water-containing zeolite often used as detergent builder is preferably zeolite A and/or P. As zeolite P, particular preference is given, for example, to zeolite MAP® (commercial product from Crosfield). Also suitable, however, are zeolite X and mixtures which contain two or more zeolites chosen from the group consisting of zeolite A, X, P or Y. Of particular interest is also a cocrystallized sodium/potassium-aluminum silicate of zeolite A and zeolite X, which is commercially available as VEGOBOND AX® (commercial product from Condea Augusta S.p.A.). The zeolite can be used as a spray-dried powder or else as an undried, stabilized suspension still moist from its preparation. If the zeolite is used as suspension, this suspension may comprise small additions of nonionic surfactants as stabilizers, for example 1 to 3% by weight, based on zeolite, of ethoxylated C₁₂-C₁₈-fatty alcohols having 2 to 5 ethylene oxide groups, C₁₂-C₁₄-fatty alcohols having 4 to 5 ethylene oxide groups or ethoxylated isotridecanols.

Suitable zeolites have an average particle size of less than 10 μm (volume distribution; measurement method: Coulter counter) and preferably contain 18 to 22% by weight, in particular 20 to 22% by weight, of bound water.

Suitable substitutes or partial substitutes for phosphates and zeolites are crystalline layered sodium silicates of the general formula NaMSiₓO2ₓ₊₁*yH₂O, where M is sodium or hydrogen, x is a number from 1.9 to 4 and y is a number from 0 to 20 and preferred values for x are 2, 3 or 4. Such crystalline phyllosilicates are described, for example, in European patent application EP 0164514 A1. Preferred crystalline phyllosilicates of the given formula are those in which M is sodium and x assumes the values 2 or 3. In particular, both β- and δ-sodium disilicates Na₂SiO₅*yH₂O are preferred, where β-sodium disilicate can, for example, be obtained by the process described in international patent application WO 91/08171. Further suitable phyllosilicates are known, for example, from the patent applications DE 2334899 A1, EP 0026529 A1 and DE 3526405 A1. Their applicability is not limited to a specific composition or structural formula. Preference is, however, given here to smectites, in particular bentonites. Suitable phyllosilicates, which belong to the group of smectites which are swellable with water, are, for example, those of the general formulae

| | |
|---|---|
| (OH) ₄Si_{8-y}Al_{y}(MgₓAl₄₋ₓ) O₂₀ | montmorillonite |
| (OH) ₄Si_{8-y}Al_{y}(Mg_{6-z}Li_{z}) O₂₀ | hectorite |
| (OH) ₄Si_{8-y}Al_{y}(Mg_{6-z}Al_{z}) O₂₀ | saponite |

where x=0 to 4, y=0 to 2, z=0 to 6. In addition, small amounts of iron may be incorporated into the crystal lattice of the phyllosilicates according to the above formulae. In addition, the phyllosilicates can, on the basis of their ion exchanging properties, contain hydrogen, alkali metal and alkaline earth metal ions, in particular Na⁺ and Ca²⁺. The amount of water of hydration is in most cases in the range from 8 to 20% by weight and is dependent on the swelling state or on the type of processing. Phyllosilicates which can be used are known, for example, from U.S. Pat. Nos. 3,966,629, 4,062,647, EP 0026529 A1 and EP 0028432 A1. Preference is given to using phyllosilicates which, on the basis of an alkaline treatment, are largely free from calcium ions and strongly coloring iron ions.

Preferred builder substances also include amorphous sodium silicates with an Na₂O:SiO₂ modulus of from 1:2 to 1:3.3, preferably from 1:2 to 1:2.8 and in particular from 1:2 to 1:2.6, which have delayed dissolution and secondary detergency properties. The dissolution delay compared with conventional amorphous sodium silicates may have been brought about here in various ways, for example by surface treatment, compounding, compaction/compression or by overdrying. For the purposes of this invention, the term “amorphous” is also to be understood as meaning “X-ray amorphous”. This means that in X-ray diffraction experiments the silicates do not give the sharp X-ray deflections typical of crystalline substances, but, at best, one or more maxima of the scattered X-rays having a breadth of several degree units of the diffraction angle. However, particularly good builder properties may very likely result even if, in the electron diffraction experiments, the silicate particles give poorly defined or even sharp diffraction maxima. This is to be interpreted to the effect that the products have microcrystalline regions with a size from 10 to a few hundred nm, preference being given to values up to at most 50 nm and in particular up to at most 20 nm. Such so-called X-ray amorphous silicates, which likewise have dissolution delay compared with conventional waterglasses, are described, for example, in German patent application DE 4400024 A1. Particular preference is given to compressed/compacted amorphous silicates, compounded amorphous silicates and overdried X-ray amorphous silicates.

A use of the generally known phosphates as builder substances is of course also possible provided such a use is not to be avoided on ecological grounds. Suitable compounds are, in particular, the sodium salts of the orthophosphates, the pyrophosphates and in particular the tripolyphosphates. Their content is generally not more than 25% by weight, preferably not more than 20% by weight, in each case based on the finished composition. In some cases it has been found that tripolyphosphates in particular, even in small amounts up to at most 10% by weight, based on the finished composition, in combination with other builder substances lead to a synergistic improvement in the secondary detergency.

Organic builder substances which can be used are, for example, the polycarboxylic acids which can be used in the form of their sodium salts, such as citric acid, adipic acid, succinic acid, glutaric acid, tartaric acid, sugar acids, aminocarboxylic acids, nitrilotriacetic acid (NTA), provided such a use is not unacceptable for ecological reasons, and mixtures thereof. Preferred salts are the salts of the polycarboxylic acids such as citric acid, adipic acid, succinic acid, glutaric acid, tartaric acid, sugar acids and mixtures thereof.

The acids per se can also be used. In addition to their builder action, the acids also typically have the property of an acidifying component and thus also serve for establishing a lower and milder pH of detergents or cleaners. In particular, mention is to be made here of citric acid, succinic acid, glutaric acid, adipic acid, gluconic acid and any mixtures thereof.

Further suitable organic builder substances are dextrins, for example oligomers or polymers of carbohydrates which can be obtained by partial hydrolysis of starches. The hydrolysis can be carried out in accordance with customary, for example acid- or enzyme-catalyzed, processes. The hydrolysis products preferably have average molar masses in the range from 400 to 500 000. In this connection, a polysaccharide with a dextrose equivalent (DE) in the range from 0.5 to 40, in particular from 2 to 30, is preferred, where DE is a customary measure of the reducing action of a polysaccharide compared with dextrose which has a DE of 100. It is also possible to use maltodextrins with a DE between 3 and 20 and dry glucose syrups with a DE between 20 and 37, and also yellow dextrins and white dextrins with higher molecular masses in the range from 2 000 to 30 000. A preferred dextrin is described in British patent application GB 9419091 A1. The oxidized derivatives of such dextrins are their reaction products with oxidizing agents which are able to oxidize at least one alcohol function of the saccharide ring to the carboxylic acid function. Such oxidized dextrins and processes for their preparation are known, for example, from the European patent applications EP 0232202 A1, EP 0427349 A1, EP 0472042 A1 and EP 0542496 A1, and international patent applications WO 92/18542, WO 93/08251, WO 93/16110, WO 94/28030, WO 95/07303, WO 95/12619 and WO 95/20608. Likewise suitable is an oxidized oligosaccharide according to the German patent application DE 19600018 A1. A product oxidized on C₆ of the saccharide ring may be particularly advantageous.

Further suitable cobuilders are oxydisuccinates and other derivatives of disuccinates, preferably ethylenediamine disuccinate. Particular preference is also given in this connection to glycerol disuccinates and glycerol trisuccinates, as are described in US-American patent specifications U.S. Pat. Nos. 4,524,009, 4,639,325, in the European patent application EP 0150930 A1 and Japanese patent application JP 93/339896. Suitable use amounts in zeolite-containing and/or silicate-containing formulations are 3 to 15% by weight.

Examples of further organic cobuilders which can be used are acetylated hydroxycarboxylic acids or salts thereof which may optionally also be present in lactone form and which contain at least 4 carbon atoms and at least one hydroxyl group and at most two acid groups. Such cobuilders are described, for example, in international patent application WO 95/20029.

Suitable polymeric polycarboxylates are, for example, the sodium salts of polyacrylic acid or of polymethacrylic acid, for example those with a relative molecular mass of from 800 to 150 000 (based on acid and in each case measured against polystyrene sulfonic acid). Suitable copolymeric polycarboxylates are, in particular, those of acrylic acid with methacrylic acid and of acrylic acid or methacrylic acid with maleic acid. Particularly suitable copolymers have proven to be those of acrylic acid with maleic acid which contain 50 to 90% by weight of acrylic acid and 50 to 10% by weight of maleic acid. Their relative molecular mass, based on free acids, is generally 5 000 to 200 000, preferably 10 000 to 120 000 and in particular 50 000 to 100 000 (in each case measured against polystyrene-sulfonic acid) . The (co)polymeric polycarboxylates can either be used as powder or as aqueous solution, preference being given to 20 to 55% strength by weight aqueous solutions. Granular polymers are in most cases mixed in afterward to one or more base granulates. Particular preference is also given to biodegradable polymers of more than two different monomer units, for example those which contain, according to DE 4300772 A1 as monomers, salts of acrylic acid and of maleic acid and vinyl alcohol or vinyl alcohol derivatives or according to DE 4221381 C2, as monomers, salts of acrylic acid and of 2-alkylallylsulfonic acid and sugar derivatives. Further preferred copolymers are those described in German patent applications DE 4303320 A1 and DE 4417734 A1 and have, as monomers, preferably acrolein and acrylic acid/acrylic acid salts or acrolein and vinyl acetate. Further preferred builder substances which are likewise to be mentioned are polymeric aminodicarboxylic acids, salts thereof or precursor substances thereof. Particular preference is given to polyaspartic acids or salts and derivatives thereof.

Further suitable builder substances are polyacetals, which can be obtained by reacting dialdehydes with polyolcarboxylic acids which have 5 to 7 carbon atoms and at least 3 hydroxyl groups, for example as described in European patent application EP 0280223 A1. Preferred polyacetals are obtained from dialdehydes such as glyoxal, glutaraldehyde, terephthalaldehyde, and mixtures thereof and from polyolcarboxylic acids such as gluconic acid and/or glucoheptonic acid.

In addition, the compositions can also comprise components which have a positive influence on the ability of oil and grease to be washed out of textiles. Preferred oil- and grease-dissolving components include, for example, nonionic cellulose ethers, such as methylcellulose and methylhydroxypropylcellulose, with a proportion of methoxy groups of from 15 to 30% by weight and of hydroxypropoxyl groups of from 1 to 15% by weight, in each case based on the nonionic cellulose ethers, and also the polymers of phthalic acid and/or of terephthalic acid known from the prior art, or of derivatives thereof, in particular polymers of ethylene terephthalates and/or polyethylene glycol terephthalates or anionically and/or nonionically modified derivatives thereof. Of these, particular preference is given to the sulfonated derivatives of phthalic acid and of terephthalic acid polymers.

Further suitable ingredients of the laundry detergents according to the invention are water-soluble inorganic salts, such as bicarbonates, carbonates, amorphous silicates, normal waterglasses which do not have excellent builder properties, or mixtures thereof: in particular, alkali metal carbonate and/or amorphous alkali metal silicate, primarily sodium silicate with a molar ratio of Na2O:SiO2 of from 1:1 to 1:4.5, preferably from 1:2 to 1:3.5, are used. The content of sodium carbonate in the laundry detergents according to the invention is preferably up to 40% by weight, advantageously between 2 and 35% by weight. The content of sodium silicate (without particular builder properties) in the compositions is generally up to 10% by weight and preferably between 1 and 8% by weight.

Apart from said ingredients, the compositions can comprise further known additives customarily used in detergents, for example antifoams, salts of polyphosphonic acids, optical brighteners, enzymes, enzyme stabilizers, small amounts of neutral filling salts, and dyes and fragrances, opacifiers or pearlizing agents.

The laundry detergents according to the invention comprise the antifoams preferably in total amounts of from 75 to 99% by weight, preferably from 80 to 95% by weight and in particular from 85 to 90% by weight. The antifoams may be wax-like compounds and/or silicone compounds. According to one embodiment of the present invention, exclusively wax-like antifoam compounds are present as antifoams. “Wax-like” compounds are to be understood as meaning those compounds which have a melting point at atmospheric pressure above 25° C. (room temperature), preferably above 50° C. and in particular above 70° C. The wax-like antifoam substances which are optionally present according to the invention are virtually insoluble in water, i.e. at 20° C. they have a solubility in 100 g of water of less than 0.1% by weight. In principle, all wax-like antifoam substances known from the prior art may be present. Suitable wax-like compounds are, for example, bisamides, fatty alcohols, fatty acids, carboxylic esters of mono- and polyhydric alcohols, and paraffin waxes or mixtures thereof. Alternatively, it is of course also possible to use the silicone compounds known for this purpose.

Suitable paraffin waxes are generally a complex mixture of substances without a sharp melting point. For characterization, its melting range is usually determined by differential thermoanalysis (DTA), as described in “The Analyst” 87 (1962), 420, and/or its solidification point is determined. This is understood as being the temperature at which the paraffin converts from the liquid state to the solid state as a result of slow cooling. In this connection, paraffins which are completely liquid at room temperature, i.e. those with a solidification point below 25° C., cannot be used according to the invention. It is possible, for example, to use the paraffin wax mixtures, known from EP 0309931 A1, of, for example, 26% by weight to 49% by weight of microcrystalline paraffin wax with a solidification point of from 62° C. to 90° C., 20% by weight to 49% by weight of hard paraffin with a solidification point of from 42° C. to 56° C. and 2% by weight to 25% by weight of soft paraffin with a solidification point of from 35° C. to 40° C. Preference is given to using paraffins or paraffin mixtures which solidify in the range from 30° C. to 90° C. In this connection, it must be taken into consideration that paraffin wax mixtures which appear solid at room temperature may also comprise varying amounts of liquid paraffin.

In the paraffin waxes which can be used according to the invention, this liquid content is as small as possible and is preferably not present at all. Thus, particularly preferred paraffin wax mixtures have a liquid content of less than 10% by weight, in particular of from 2% by weight to 5% by weight, at 30° C., a liquid content of less than 30% by weight, preferably of from 5% by weight to 25% by weight and in particular from 5% by weight to 15% by weight at 40° C., a liquid content of from 30% by weight to 60% by weight, in particular from 40% by weight to 55% by weight, at 60° C., a liquid content of from 80% by weight to 100% by weight at 80° C., and a liquid content of 100% by weight at 90° C. The temperature at which a liquid content of 100% by weight of the paraffin wax is achieved is, in the case of particularly preferred paraffin wax mixtures, still less than 85° C., in particular 75° C. to 82° C. The paraffin waxes may be petrolatum, microcrystalline waxes or hydrogenated or partially hydrogenated paraffin waxes.

Bisamides suitable as antifoams are those derived from saturated fatty acids having 12 to 22, preferably 14 to 18, carbon atoms, and from alkylenediamines having 2 to 7 carbon atoms. Suitable fatty acids are lauric acid, myristic acid, stearic acid, arachidic acid and behenic acid, and mixtures thereof, as are obtainable from natural fats or hydrogenated oils, such as tallow or hydrogenated palm oil. Suitable diamines are, for example, ethylenediamine, 1,3-propylenediamine, tetramethylenediamine, pentamethylenediamine, hexamethylenediamine, p-phenylenediamine and tolylenediamine. Preferred diamines are ethylenediamine and hexamethylenediamine. Particularly preferred bisamides are bismyristoylethylenediamine, bispalmitoylethylenediamine, bisstearoylethylenediamine and mixtures thereof, and the corresponding derivatives of hexamethylenediamine.

Carboxylic esters suitable as antifoams are derived from carboxylic acids having 12 to 28 carbon atoms. In particular, these are esters of behenic acid, stearic acid, hydroxystearic acid, oleic acid, palmitic acid, myristic acid and/or lauric acid. The alcohol moiety of the carboxylic ester contains a mono- or polyhydric alcohol having 1 to 28 carbon atoms in the hydrocarbon chain. Examples of suitable alcohols are behenyl alcohol, arachidyl alcohol, coconut alcohol, 12-hydroxystearyl alcohol, oleyl alcohol and lauryl alcohol, and also ethylene glycol, glycerol, polyvinyl alcohol, sucrose, erythritol, pentaerythritol, sorbitan and/or sorbitol. Preferred esters are those of ethylene glycol, glycerol and sorbitan, where the acid moiety of the ester is chosen in particular from behenic acid, stearic acid, oleic acid, palmitic acid or myristic acid. Suitable esters of polyhydric alcohols are, for example, xylitol monopalmitate, pentaerythritol monostearate, glycerol monostearate, ethylene glycol monostearate and sorbitan monostearate, sorbitan palmitate, sorbitan monolaurate, sorbitan dilaurate, sorbitan distearate, sorbitan dibehenate, sorbitan dioleate, and mixed tallow alkylsorbitan mono- and diesters. Glycerol esters which can be used are the mono-, di- or triesters of glycerol and said carboxylic acids, preference being given to the mono- or diesters. Glycerol monostearate, glycerol monooleate, glycerol monopalmitate, glycerol monobehenate and glycerol distearate are examples thereof. Examples of natural esters suitable as antifoams are beeswax, which consists mainly of the esters CH₃(CH₂)₂₄COO(CH₂)₂₇CH₃ and CH₃(CH₂)₂₆COO(CH₂)₂₅CH₃, and carnauba wax, which is a mixture of carnaubic acid alkyl esters, often in combination with small amounts of free carnaubic acid, further long-chain acids, high molecular weight alcohols and hydrocarbons.

Carboxylic acids likewise suitable as antifoam compound are, in particular, behenic acid, stearic acid, oleic acid, palmitic acid, myristic acid and lauric acid, and mixtures thereof, as are obtainable from natural fats or optionally hydrogenated oils, such as tallow or hydrogenated palm oil. Preference is given to saturated fatty acids having 12 to 22, in particular 18 to 22, carbon atoms.

Fatty alcohols likewise suitable as antifoam compound are the hydrogenated products of the fatty acids described. Furthermore, dialkyl ethers may additionally be present as antifoams. The ethers may have an asymmetric or else a symmetric structure, i.e. contain two identical or different alkyl chains, preferably having 8 to 18 carbon atoms. Typical examples are di-n-octyl ether, di-isooctyl ether and di-n-stearyl ether, and dialkyl ethers which have a melting point greater than 25° C., in particular greater than 40° C., are particularly suitable.

Further suitable antifoam compounds are fatty ketones of the formula (III),

R¹—CO—R² (III)

in which R¹ and R², independently of one another, are linear or branched hydrocarbon radicals having 11 to 25 carbon atoms and 0 or 1 double bond. Such ketones are known substances which can be obtained by the relevant methods of preparative organic chemistry. They are prepared, for example, starting from carboxylic acid magnesium salts, which are pyrolyzed at temperatures above 300° C. with the elimination of carbon dioxide and water, for example in accordance with German laid-open specification DE 2553900 A. Suitable fatty ketones are those prepared by pyrrolysis of the magnesium salts of lauric acid, myristic acid, palmitic acid, palmitoleic acid, stearic acid, oleic acid, elaidic acid, petroselic acid, arachidic acid, gadoleic acid, behenic acid or erucic acid. Preference is given to 16-hentriacontanone; (R¹ and R² is an alkyl radical having 15 carbon atoms) , 17-tritriacontanone (R¹ and R² is an alkyl radical having 16 carbon atoms), stearone (18-pentatriacontanone; R¹ and R² is an alkyl radical having 17 carbon atoms), 19-heptatriacontanone (R¹ and R² is an alkyl radical having 18 carbon atoms) , arachinone (20-nonatriacontanone; R¹ and R² is an alkyl radical having 19 carbon atoms), 21-hentetracontanone (R¹ and R² is an alkyl radical having 20 carbon atoms) and/or behenone (22-triatetracontanone; R¹ and R² is an alkyl radical having 21 carbon atoms).

Further suitable antifoams are fatty acid polyethylene glycol esters of the formula (IV),

R³COO(CH₂CH₂O)ₙH (IV)

in which R³CO is a linear or branched, aliphatic, saturated and/or unsaturated acyl radical having 6 to 22 carbon atoms and n is a number from 0.5 to 1.5. Such fatty acid polyethylene glycol esters are preferably obtained by basic-homogeneously catalyzed addition of ethylene oxide onto fatty acids, the addition of ethylene oxide onto the fatty acids taking place in particular in the presence of alkanolamines as catalysts. The use of alkanolamines, specifically tri-ethanolamine, leads to a highly selective ethoxylation of the fatty acids, particularly when the compounds to be prepared have low degrees of ethoxylation. For the purposes of the present invention, preference is given to fatty acid polyethylene glycol esters of the formula (II) in which R³CO is a linear acyl radical having 12 to 18 carbon atoms and n is 1. Lauric acid ethoxylated with 1 mol of ethylene oxide is particularly suitable. Within the group of fatty acid polyethylene glycol esters, preference is given to those which have a melting point above 25° C., in particular above 40° C.

According to a further embodiment of the present invention, the laundry detergents according to the invention comprise, as antifoam, a mixture of at least one wax-like antifoam, preferably a paraffin wax, and a defoaming silicone compound. For the purposes of the present invention, suitable silicones are customary organopolysiloxanes which may have a content of finely divided silica, which may in turn also be silanized. Such organopolysiloxanes are described, for example, in European patent application EP 0496510 A1. Particular preference is given to polydiorganosiloxanes which are known from the prior art. Suitable polydiorganosiloxanes can have a virtually linear chain and are characterized according to the following formula (III), where R⁴, independently of the others, may be an alkyl or an aryl radical and z may be a number in the range from 40 to 1 500. Examples of suitable substituents R⁴ are methyl, ethyl, propyl, isobutyl, tert-butyl and phenyl. It is, however, also possible to use compounds crosslinked via siloxane, as are known to the person skilled in the art under the name silicone resins. The polydiorganosiloxanes usually comprise finely divided silica, which may also be silanized. Silica-containing dimethylpolysiloxanes are particularly suitable. The polydiorganosiloxanes preferably have a Brookfield viscosity at 25° C. in the range from 5 000 mPas to 30 000 mPas, in particular from 15 000 to 25 000 mPas. The silicones are preferably applied to carrier materials. Suitable carrier materials have already been described in connection with the paraffins. The carrier materials are generally present in amounts of from 40 to 90% by weight, preferably in amounts of from 45 to 75% by weight—based on antifoams.

In a further preferred embodiment of the present invention, the laundry detergents according to the invention comprise, as antifoam compound, at least one wax-like compound and one antifoam silicone compound.

In a further preferred embodiment of the present invention, the laundry detergents according to the invention comprise, as antifoam compound,

(a) at least one soft wax with a melting point in the range from 35 to 50° C.,

(b) at least one hard wax with a melting point above 50° C.,

(c) optionally silicone and

(d) carrier materials (soda, sodium sulfate, zeolite, silicate, starch, cellulose, etc.).

In a further preferred embodiment of the present invention, the laundry detergent additives according to the invention comprise, as antifoam compound,

(e) 5 to 25% by weight of at least one soft wax with a melting point in the range from 35 to 50° C.,

(f) 1 to 10% by weight of at least one hard wax with a melting point above 50° C.,

(g) 1 to 10% by weight of at least one amide wax with a melting point above 100° C.,

(h) 0 to 10% by weight of silicones and

(i) ad 100% by weight of carrier materials (soda, Na sulfate, zeolite, silicate, starch, cellulose, etc.).

In a further preferred embodiment of the present invention, the laundry detergents according to the invention comprise, in the antifoam component, as soft wax, petrolatums or hydrogenation products thereof. The preferred soft waxes are paraffin mixtures in the carbon chain range from C₂₀ to C₆₀, where about 80% is in the carbon chain range from C₂₅ to C₅₀. The preferred paraffin mixture comprises linear and also branched paraffins in a ratio of about 40:60. The paraffin mixture can also comprise hydrogenated paraffins.

In a further preferred embodiment of the present invention, the laundry detergents according to the invention comprise, in the antifoam component, as hard wax, microcrystalline waxes which are in the carbon chain range from C₂₅ to C₅₀ and have a softening point of >50° C.

Of the compounds which serve as bleaches and produce H₂O₂ in water, sodium perborate tetrahydrate and sodium perborate monohydrate are of particular importance.

Further suitable bleaches are, for example, sodium percarbonate, peroxypyrophosphates, citrate perhydrates, and H₂O₂-producing peracidic salts or peracids, such as perbenzoates, peroxophthalates, diperazelaic acid, phthaloiminoperacid or diper-dodecanedioic acid. The content of bleaches in the compositions is preferably 5 to 35% by weight and in particular up to 30% by weight, with perborate monohydrate or percarbonate advantageously being used.

Bleach activators which may be used are compounds which under perhydrolysis conditions produce aliphatic peroxocarboxylic acids having preferably 1 to 10 carbon atoms, in particular 2 to 4 carbon atoms, and/or optionally substituted perbenzoic acid. Suitable substances are those which carry O- and/or N-acyl groups of said number of carbon atoms and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexa-hydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl or isononanoyl oxybenzenesulfonate (n- or iso-NOBS), carboxylic anhydrides, in particular phthalic anhydride, acylated polyhydric alcohols, in particular triacetin, ethylene glycol diacetate, 2,5-diacetoxy-2,5-dihydrofuran and the enol esters known from German patent applications DE 19616693 A1 and DE 19616767 A1, and also acetylated sorbitol and mannitol or mixtures thereof (SORMAN) described in European patent application EP 0525239 A1, acylated sugar derivatives, in particular pentaacetylglucose (PAG), pentaacetyl-fructose, tetraacetylxylose and octaacetyllactose, and acetylated, optionally N-alkylated glucamine and gluconolactone, and/or N-acylated lactams, for example N-benzoylcaprolactam, which are known from international patent applications WO 94/27970, WO 94/28102, WO 94/28103, WO 95/00626, WO 95/14759 and WO 95/17498.

The hydrophilically substituted acylacetals known from German patent application DE 19616769 A1 and the acyllactams described in German patent application DE 19616 770 and international patent application WO 95/14075 are likewise preferably used. The combinations of conventional bleach activators known from German patent application DE 4443177 A1 can also be used. Such bleach activators are present in the customary quantitative range, for example in amounts of from 1% by weight to 10% by weight, in particular 2% by weight to 8% by weight, based on the total composition.

In addition to the abovementioned conventional bleach activators, or instead of them, it is also possible for the sulfonimines and/or bleach-boosting transition metal salts or transition metal complexes known from the European patent specifications EP 0446982 B1 and EP 0453 003 B1 to be present as bleach catalysts. Suitable transition metal compounds include, in particular, the manganese-, iron-, cobalt-, ruthenium- or molybdenum-salen complexes known from German patent application DE 19529905 A1, and their N-analogous compounds known from German patent application DE 19620267 A1, the manganese-, iron-, cobalt-, ruthenium- or molybdenum-carbonyl complexes known from German patent application DE 19536082 A1, the manganese, iron, cobalt, ruthenium, molybdenum, titanium, vanadium and copper complexes with N-containing tripod ligands described in German patent application DE 196 05 688, the cobalt-, iron-, copper- and ruthenium-amine complexes known from German patent application DE 19620411 A1, the manganese, copper and cobalt complexes described in German patent application DE 4416438 A1, the cobalt complexes described in European patent application EP 0272030 A1, the manganese complexes known from European patent application EP 0693550 A1, the manganese, iron, cobalt and copper complexes known from European patent specification EP 0392592 A1 and/or the manganese complexes described in European patent specification EP 0443651 B1 or European patent applications EP 0458397 A1, EP 0458398 A1, EP 0549271 A1, EP 0549272 A1, EP 0544490 A1 and EP 0544519 A1. Combinations of bleach activators and transition metal bleach catalysts are known, for example, from German patent application DE 19613103 A1 and international patent application WO 95/27775.

Bleach-boosting transition metal complexes, in particular those with the central atoms Mn, Fe, Co, Cu, Mo, V, Ti and/or Ru, are used in customary amounts, preferably in an amount up to 1% by weight, in particular from 0.0025% by weight to 0.25% by weight and particularly preferably from 0.01% by weight to 0.1% by weight, in each case based on the total composition.

Suitable enzymes are, in particular, those from the class of hydrolases, such as proteases, esterases, lipases and enzymes with lipolytic action, amylases, cellulases or other glycosyl hydrolases and mixtures of said enzymes. In the washing, all of these hydrolases contribute to the removal of stains, such as proteinacous, fatty or starchy marks, and graying. Cellulases and other glycosyl hydrolases may contribute to the retention of color and to an increase in the softness of the textile by removing pilling and microfibrils. For bleaching and/or for inhibiting color transfer, it is also possible to use oxidoreductases. Especially suitable enzymatic active ingredients are those obtained from bacterial strains or fungi, such as Bacillus subtilis, Bacillus licheniformis, Streptomyces griseus and Humicola insolens. Preference is given to using proteases of the Subtilisin type, and especially to proteases obtained from Bacillus lentus. Of particular interest in this context are enzyme mixtures, for example of protease and amylase or protease and lipase or enzymes with a lipolytic action or protease and cellulase or of cellulase and lipase or enzymes with a lipolytic action or of protease, amylase and lipase or enzymes with a lipolytic action or protease, lipase or enzymes with a lipolytic action and cellulase, but in particular protease- and/or upase-containing mixtures or mixtures containing enzymes with a lipolytic action. Examples of such enzymes with a lipolytic action are the known cutinases. Peroxidases or oxidases have also proven suitable in some cases. Suitable amylases include, in particular, α-amylases, isoamylases, pullulanases and pectinases. The cellulases used are preferably cellobiohydrolases, endoglucanases and β-glucosidases, which are also called cellobiases, or mixtures thereof. Because different types of cellulase differ in their CMCase and avicelase activities, specific mixtures of the cellulases may be used to establish the desired activities.

The enzymes can be adsorbed to carrier substances and/or be embedded in coating substances in order to protect them from premature decomposition. The proportion of enzymes, enzyme mixtures or enzyme granulates can, for example, be about 0.1 to 5% by weight, preferably 0.1 to about 2% by weight.

In addition to the mono- and polyfunctional alcohols, the compositions can comprise further enzyme stabilizers. For example, 0.5 to 1% by weight of sodium formate can be used. The use of proteases stabilized with soluble calcium salts and a calcium content of preferably about 1.2% by weight, based on the enzyme, is also possible. Apart from calcium salts, magnesium salts also serve as stabilizers. However, the use of boron compounds, for example of boric acid, boron oxide, borax and other alkali metal borates, such as the salts of orthoboric acid (H₃BO₃), of metaboric acid (HBO₂) and of pyroboric acid (tetraboric acid H₂B₄O₇) is particularly advantageous.

Graying inhibitors have the function of keeping the soil detached from the fiber suspended in the liquor, thus preventing reattachment of the soil. Suitable for this purpose are water-soluble colloids, usually organic in nature, examples being the water-soluble salts of polymeric carboxylic acids, glue, gelatin, salts of ether carboxylic acids or ether sulfonic acids of starch or of cellulose or salts of acidic sulfuric esters of cellulose or of starch. Water-soluble polyamides containing acidic groups are also suitable for this purpose. Furthermore, soluble starch preparations and starch products other than those mentioned above may be used, e.g. degraded starch, aldehyde starches, etc. Polyvinylpyrrolidone may also be used. Preference, however, is given to using cellulose ethers, such as carboxymethyl cellulose (Na salt), methyl cellulose, hydroxyalkyl cellulose and mixed ethers, such as methylhydroxyethyl cellulose, methylhydroxypropyl cellulose, methylcarboxymethyl cellulose and mixtures thereof, and polyvinylpyrrolidone, for example in amounts of from 0.1 to 5% by weight, based on the compositions.

The compositions may comprise, as optical brighteners, derivatives of diaminostilbenedisulfonic acid or alkali metal salts thereof. Examples of suitable derivatives are salts of 4,4′-bis(2-anilino-4-morpholino-1,3,5-triazinyl-6-amino)stilbene-2,2′-disulfonic acid or compounds of a similar structure which carry a diethanolamino group, a methylamino group, an anilino group or a 2-methoxyethylamino group instead of the morpholino group. Furthermore, brighteners of the substituted diphenylstyryl type may be present, e.g. the alkali metal salts of 4,4′-bis(2-sulfostyryl)-diphenyl, 4,4′-bis(4-chloro-3-sulfostyryl)diphenyl or 4-(4-chlorostyryl)-4′-(2-sulfostyryl)diphenyl. It is also possible to use mixtures of the abovementioned brighteners. Uniformly white granulates are obtained if the compositions comprise, apart from the customary brighteners in customary amounts, for example between 0.1 and 0.5% by weight, preferably between 0.1 and 0.3% by weight, also small amounts, for example 10⁻⁶ to 10⁻³% by weight, preferably around 10⁻⁵% by weight, of a blue dye. A particularly preferred dye is TINOLUX® (commercial product from Ciba-Geigy).

Suitable soil repellent polymers are those substances which preferably contain ethylene terephthalate and/or polyethylene glycol terephthalate groups, where the molar ratio of ethylene terephthalate to polyethylene glycol terephthalate may be in the range from 50:50 to 90:10. The molecular weight of the linking polyethylene glycol units is in particular in the range from 750 to 5 000, i.e. the degree of ethoxylation of the polyethylene glycol group-containing polymers may be about 15 to 100. The polymers are characterized by an average molecular weight of from about 5 000 to 200 000 and can have a block structure, but preferably have a random structure. Preferred polymers are those with ethylene terephthalate/polyethylene glycol terephthalate molar ratios of from about 65:35 to about 90:10, preferably from about 70:30 to 80:20. In addition, preference is given to those polymers which have linking polyethylene glycol units with a molecular weight of from 750 to 5 000, preferably from 1 000 to about 3 000 and a molecular weight of the polymer of from about 10 000 to about 50 000. Examples of commercially available polymers are the products MILEASE® T (ICI) or REPELOTEX® SRP 3 (Rhône-Poulenc).

Perfume oils or fragrances which can be used are individual odorant compounds, e.g. the synthetic products of the ester, ether, aldehyde, ketone, alcohol and hydrocarbon type. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexylpropionate, styrallyl propionate and benzyl salicylate. The ethers include, for example, benzyl ethyl ether; the aldehydes include, for example, the linear alkanals having 8-18 carbon atoms, citral, citronellal, citronellyloxy-acetaldehyde, cyclamenaldehyde, hydroxycitronellal, ulial and bourgeonal, the ketones include, for example, the ionones, α-isomethylionone and methyl cedryl ketone, the alcohols include anethole, citronellol, eugenol, geraniol, linalool, phenylethyl alcohol and terpineol, and the hydrocarbons include mainly the terpenes, such as limonene and pinene. Preference is, however, given to using mixtures of different odorants which together produce a pleasing fragrance note. Such perfume oils can also contain natural odorant mixtures, as are obtainable from plant sources, e.g. pine oil, citrus oil, jasmine oil, patchouli oil, rose oil or ylang ylang oil. Likewise suitable are clary sage oil, chamomile oil, clove oil, melissa oil, mint oil, cinnamon leaf oil, lime blossom oil, juniperberry oil, vetiver oil, olibanum oil, galbanum oil and labdanum oil, and also orange blossom oil, neroliol, orange peel oil and sandalwood oil. The fragrances can be incorporated directly into the compositions according to the invention, although it may also be advantageous to apply the fragrances to carriers which intensify adhesion of the perfume to the laundry and, as a result of a slower fragrance release, provide for long-lasting fragrance of the textiles. Cyclodextrins have, for example, proven useful as such carrier materials, where the cyclodextrin-perfume complexes can additionally be coated with further auxiliaries.

If desired, the detergents according to the invention can also comprise inorganic salts as fillers or extenders, such as, for example, sodium sulfate, which is preferably present in amounts of from 0 to 10% by weight, in particular 1 to 5% by weight—based on composition.

Preparation

The laundry detergents according to the invention obtainable using said additives can be prepared and used in the form of powders, extrudates, granulates or tablets. To prepare such compositions, the corresponding processes known from the prior art are suitable. The compositions are preferably prepared by mixing together various particulate components which comprise detergent ingredients. In this process, the particulate components can be prepared by spray drying, simple mixing or complex granulation processes, for example fluidized bed granulation. In this connection, it is particularly preferred for at least one surfactant-containing component to be prepared by fluidized bed granulation. In addition, it may be particularly preferred if aqueous preparations of the alkali metal silicate and of the alkali metal carbonate are sprayed together with other detergent ingredients in a drying device, it being possible for granulation to take place at the same time as the drying. The drying device into which the aqueous preparation is sprayed can be any desired drying apparatus.

In a preferred process embodiment, the drying is carried out as spray drying in a drying tower. For this, the aqueous preparations are subjected, in a known manner, to a drying gas stream in finely divided form. Patent publications from Henkel describe an embodiment of spray drying with superheated steam. The operating principle disclosed therein is thus expressly also included in the subject-matter of the present inventive disclosure. Reference is made in this connection in particular to the following publications: DE 4030688 A1 and the continuing publications according to DE 4204035 A1, DE 4204090 A1, DE 4206050 A1, DE 4206521 A1, DE 4206495 A1, DE 4208773 A1, DE 4209432 A1 and DE 4234376 A1.

In another preferred variant, in particular if compositions of high bulk density are to be obtained, the mixtures are then subjected to a compacting step, further ingredients only being added to the compositions after the compacting step. Compaction of the ingredients takes place in a preferred embodiment of the invention in a compression agglomeration process. The compression agglomeration operation to which the solid premix (dried base detergent) is subjected can be realized in various apparatuses. Depending on the type of agglomerator used, various compression agglomeration processes are differentiated. The four most common and preferred compression agglomeration processes for the purposes of the present invention are extrusion, roll compression or compaction, perforation compression (pelleting) and tableting, meaning that, for the purposes of the present invention, preferred compression agglomeration operations are extrusion, roll compaction, pelleting or tableting operations. A common feature of all of these processes is that the premix is compacted under pressure and plasticized and the individual particles are pressed together, with a reduction in the porosity, and adhere to one another. In all of the processes (in the case of tableting with limitations) , the tools can be heated to relatively high temperatures or cooled to dissipate the heat which forms as a result of shear forces. In all of the processes, one or more binders can be used as auxiliary for the compression. In this connection, however, it should be clarified that the use of two or more different binders and mixtures of different binders is also always possible in itself. In a preferred embodiment of the invention, a binder is used which is already completely in the form of a melt at temperatures up to at most 130° C., preferably up to at most 100° C. and in particular up to 90° C. The binder must thus be chosen depending on the process and process conditions, or the process conditions, in particular the process temperature, have to be adapted—if a certain binder is desired—to the binder. The actual compression process is preferably carried out at processing temperatures which, at least in the compression step, correspond to at least the temperature of the softening point if not even the temperature of the melting point of the binder.

In a preferred embodiment of the invention, the processing temperature is significantly greater than the melting point or greater than the temperature at which the binder is in the form of a melt. In particular, however, it is preferred that the processing temperature in the compression step is not more than 20° C. above the melting temperature or the upper limit of the melting range of the binder. Although it is technically entirely possible to establish even higher temperatures, it has, however, been found that a temperature difference relative to the melting temperature or to the softening temperature of the binder of 20° C. is generally entirely adequate and even higher temperatures do not afford any additional advantages. For this reason, it is particularly preferred—in particular also for energetic reasons—to work above, but as close as possible to, the melting point or to the upper temperature limit of the melting range of the binder. Such a temperature control has the added advantage that thermally sensitive raw materials, for example peroxy bleaches, such as perborate and/or percarbonate, and also enzymes, can also be increasingly processed without serious losses of active substance. The possibility of exact temperature control of the binder, in particular in the decisive step of compression, i.e. between mixing/homogenization of the premix and shaping, permits an energetically very favorable process control which is extremely gentle for the temperature-sensitive constituents of the premix since the premix is only exposed to the higher temperatures for a short period.

In preferred compression agglomeration processes, the processing tools of the compression agglomerator (the screw(s) of the extruder, the roll(s) of the roll compactor and the compression roll(s) of the pelleting press) have a temperature of at most 150° C., preferably at most 100° C. and in particular at most 75° C., and the processing temperature is 30° C. and in particular at most 20° C. above the melting temperature or the upper temperature limit of the melting range of the binder. The duration of the temperature effect in the compression zone of the compression agglomerators is preferably at most 2 minutes and is in particular in a range between 30 seconds and 1 minute.

Preferred binders, which can be used alone or in a mixture with other binders, are polyethylene glycols, 1,2-polypropylene glycols, and modified polyethylene glycols and polypropylene glycols. Modified polyalkylene glycols include, in particular, the sulfates and/or the disulfates of polyethylene glycols or polypropylene glycols with a relative molecular mass between 600 and 12 000 and in particular between 1 000 and 4 000. A further group consists of mono- and/or disuccinates of the polyalkylene glycols, which in turn have relative molecular masses between 600 and 6 000, preferably between 1 000 and 4 000. For a more precise description of the modified polyalkylene glycol ethers, reference is made to the disclosure of international patent application WO 93/02176. For the purposes of this invention, polyethylene glycols include those polymers for whose preparation, as well as ethylene glycol, C₃-C₅-glycols and glycerol and mixtures thereof are likewise used as starting molecules. In addition, ethoxylated derivatives, such as trimethylolpropane having 5 to 30 EO are included. The preferred polyethylene glycols can have a linear or branched structure, preference being given in particular to linear polyethylene glycols. Particularly preferred polyethylene glycols include those with relative molecular masses between 2 000 and 12 000, advantageously around 4 000, where it is possible to use polyethylene glycols with relative molecular masses below 3 500 and above 5 000, in particular in combination with polyethylene glycols with a relative molecular mass around 4 000, and such combinations advantageously have more than 50% by weight, based on the total amount of polyethylene glycols, of polyethylene glycols with a relative molecular mass between 3 500 and 5 000. Binders which can be used, however, are also polyethylene glycols which are per se in liquid state at room temperature and a pressure of 1 bar; polyethylene glycol with a relative molecular mass of 200, 400 and 600 is primarily suitable. However, these polyethylene glycols, which are liquid per se, should only be used in a mixture with at least one other binder, this mixture again having to satisfy the requirements according to the invention, i.e. must have a melting point or softening point of at least more than 45° C. Other suitable binders are lower molecular weight polyvinylpyrrolidones and derivatives thereof having relative molecular masses up to at most 30 000. Preference is given here to relative molecular mass ranges between 3 000 and 30 000, for example around 10 000. Polyvinylpyrrolidones are preferably not used as the sole binder, but in combination with others, in particular in combination with polyethylene glycols.

Directly after leaving the preparation apparatus, the compressed material preferably has temperatures not exceeding 90° C., temperatures between 35 and 85° C. being particularly preferred. It has been found that exit temperatures—primarily in the extrusion process—of from 40 to 80° C., for example up to 70° C., are particularly advantageous.

In a preferred embodiment, the laundry detergent according to the invention is prepared by means of extrusion, as described, for example, in European patent EP 0486592 B1 or international patent applications WO 93/02176 and WO 94/09111 and WO 98/12299. In this process, a solid premix is compressed in the form of strands under pressure and, after leaving the perforated die, the strand is cut to the predeterminable granulate dimension by means of a cutting device. The homogeneous and solid premix comprises a plasticizer and/or lubricant, which means that the premix softens plastically and becomes extrudable under the pressure or the input of specific work. Preferred plasticizers and/or lubricants are surfactants and/or polymers. To explain the actual extrusion process, reference is expressly made here to the abovementioned patents and patent applications. Preferably, in this connection, the premix is preferably fed to a planetary roll extruder or a 2-shaft extruder or 2-screw extruder with coacting or counteracting screw control, the housing of which and the extruder granulation head of which can be heated to the predetermined extrusion temperature. Under the shear action of the extruder screws, the premix is compressed under pressure, which is preferably at least 25 bar, but can also be lower in cases of extremely high throughputs and depending on the apparatus used, plasticized, extruded in the form of fine strands through the perforated die plate in the extruder head and finally the extrudate is comminuted using a rotating chopping knife preferably to give approximately spherical to cylindrical granulate particles. The perforation diameter of the perforated die plate and the strand section length are matched to the chosen granulate dimension. Thus, the preparation of granulates of an essentially uniformly predeterminable particle size is possible, it being possible, in individual cases, to match the absolute particle sizes to the intended use purpose. In general, particle diameters up to at most 0.8 cm are preferred.

Important embodiments here provide the preparation of uniform granulates in the millimeter range, for example in the range from 0.5 to 5 mm and in particular in the range from about 0.8 to 3 mm. The length/diameter ratio of the chopped primary granulates is here preferably in the range from about 1:1 to about 3:1. It is also preferred to pass the still plastic primary granulate to a further shaping processing step; here, edges present on the crude extrudate are rounded, meaning that ultimately it is possible to obtain spherical to approximately spherical extrudate particles. If desired, small amounts of dry powder, for example zeolite powder, such as zeolite NaA powder, can be coused in this stage. This shaping can be carried out in commercially available rounding devices. Here, it must be ensured that only small amounts of fines arise in this stage. Drying, which is described in the abovementioned documents of the prior art as a preferred embodiment, is then possible, but not obligatory.

It may be preferable not to carry out any more drying after the compaction step. Alternatively, extrusions/compressions can also be carried out in low-pressure extruders, in the Kahl press (Amandus Kahl) or in a Bextruder from Bepex. The temperature is preferably controlled in the transition zone of the screw, of the predistributor and of the die plate in such a way that the melting temperature of the binder or the upper limit of the melting range of the binder is at least reached, but preferably exceeded. In this connection, the duration of the temperature effect in the compression zone of the extrusion is preferably below 2 minutes and in particular in a range between 30 seconds and 1 minute.

The laundry detergents according to the invention can also be prepared by means of roll compaction. Here, the premix is fed in in a targeted manner between two smooth rolls or rolls provided with indentations of defined shape, and rolled out between the two rolls under pressure to give a sheetlike compact, so-called flakes. The rolls exert a high linear pressure on the premix and can, if required, additionally be heated or chilled. The use of smooth rolls gives smooth, unstructured flake strands, while the use of structured rolls can produce correspondingly structured flakes in which, for example, certain shapes of the subsequent detergent particles can be preset. The flake strand is then broken into smaller sections by a chopping and comminution operation and can be processed in this way to give granulate particles which can be finished by further surface-treatment processes known per se, in particular can be converted to an approximately spherical shape. In the case of roll compaction too, the temperature of the pressing tools, i.e. of the rolls, is preferably at most 150° C., preferably at most 100° C. and in particular at most 75° C.

Particularly preferred preparation processes operate in the case of roll compaction at processing temperatures which are 10° C., in particular at most 5° C., above the melting temperature or the upper temperature limit of the melting range of the binder. In this connection, it is further preferred that the duration of the temperature effect in the compression zone of the smooth rolls or rolls provided with indentations of defined form is at most 2 minutes and is in particular in a range between 30 seconds and 1 minute.

The laundry detergent according to the invention can also be prepared by means of pelleting. Here, the premix is applied to a perforated surface and pressed through the holes by means of a pressure-exerting body with plastification. With customary variants of pelleting presses, the premix is compressed under pressure, plasticized, pressed through a perforated surface by means of a rotating roll in the form of fine strands and finally comminuted using a chopping device to give granulate particles. In this connection, a very wide variety of configurations of pressure rolls and perforated dies are conceivable. Thus, for example, flat perforated plates are used, as are concave or convex annular dies through which the material is pressed by means of one or more pressure rolls. The pressure rolls can also be conical in shape in the case of the plate devices, and in the annular devices, dies and pressure roll(s) can be corotating or counterrotating.

An apparatus suitable for carrying out the process is described, for example, in German laid-open specification DE 3816842 A1. The annular die press disclosed in this specification consists of a rotating annular die interspersed by pressure channels, and at least one pressure roll which cooperates with the inside surface of the annular die and which presses the material introduced into the inside of the die through the compression channels into a material discharge. Here, annular dies and compression roll(s) can be operated in the same direction, as a result of which it is possible to achieve reduced shear stress and therefore a lower temperature increase of the premix. However, it is of course also possible to use heatable or chillable rolls during the pelleting in order to establish a desired temperature of the premix. In the case of pelleting too, the temperature of the compression tools, i.e. of the compression rolls or pressure rolls, is preferably at most 150° C., more preferably at most 100° C. and in particular at most 75° C. Particularly preferred preparation processes operate in the case of roll compaction at processing temperatures which are 10° C., in particular at most 5° C., above the melting temperature or the upper temperature limit of the melting range of the binder.

A further compression agglomeration process which can be used to prepare the laundry detergents according to the invention is tableting. Because of the size of the moldings prepared, in the case of tableting it may be useful to add, in addition to the binder described above, customary disintegration auxiliaries, for example cellulose and its derivatives, in particular in coarse form, or crosslinked PVP, which facilitate disintegration of the compacts in the wash liquor. The resulting particulate compression agglomerates can either be used directly as laundry detergents or be after-treated and/or worked up by customary methods beforehand. Customary after-treatments include, for example, powdering with finely divided ingredients of laundry detergents or cleaners, as a result of which the bulk weight is generally further increased. However, a preferred after-treatment is also the procedure according to German patent applications DE 19524287 A1 and DE 19547457 A1, where dust-like or at least finely divided ingredients (so-called fines) are adhered to the particulate process end-products prepared according to the invention, which serve as core, thus giving compositions which have these fines as external shell. This in turn is advantageously carried out by melt agglomeration.

For details of the melt agglomeration of the fines, reference is expressly made to the disclosure in German patent applications DE 19524287 A1 and DE 19547457 A1. In the preferred embodiment of the invention, the solid detergents are in tablet form, these tablets in particular having preferably rounded corners and edges for storage and transportation reasons. The basic area of these tablets can, for example, be circular or rectangular. Multilayer tablets, in particular tablets with 2 or 3 layers, which may also be of different colors, are primarily preferred. Blue-white or green-white or blue-green-white tablets are particularly preferred. Detergent tablets generally comprise a disintegrant which is intended to effect rapid dissolution of the tablet or the rapid disintegration of the tablet in the aqueous liquor. In this connection, reference is expressly made to the contents of the German patent applications DE 19709991 A1 and DE 19710254 A1 in which preferred cellulose-based disintegrant granules are described.

The invention further provides for the use of surfactant compositions according to the invention for the preparation of laundry detergents.

The invention likewise provides for the use of surfactant compositions according to the invention or of surfactant compositions prepared by a process according to the invention for the preparation of laundry detergents in the form of powders, granulates, extrudates, agglomerates or tablets.

The invention is illustrated in more detail below by examples.

### EXAMPLES

### Example 1

a) Preparation of the carrier material for the liquid nonionic surfactant

The following constituents were mixed with the addition of water to give a slurry (pbw=parts by weight) in a mixing vessel equipped with stirring device

a) 67.4 pbw of zeolite NaA (calculated on an anhydrous basis),

b) 2.1 pbw of ethoxylated tallow-fatty alcohol with 5 EO as dispersion stabilizer

c) 4.0 pbw of acrylic acid-maleic acid copolymer (Na salt)

d) 2.5 pbw of Na soap (C12-18-coconut-tallow soap 1:1)

e) 4.4 pbw of sodium sulfate

It was used as aqueous dispersion (filtercake) comprising 48% by weight of anhydrous zeolite, and the other additives mentioned under (a) and 50.2% by weight of water. The polycarboxylic acid used was a copolymer of acrylic acid and maleic acid with a molecular weight of 70 000 (Sokalan in the form of the sodium salt.

The aqueous slurry having a temperature of 85° C. and a viscosity of 10 200 mPas was sprayed at a pressure of 40 AT in a tower in which combustion gases with a temperature of 226° C. (measured in the ring channel) were passed in countercurrent to the spray product. The exit temperature of the dry gas was 63° C. The granular adsorption agent leaving the spray tower comprised 19.6 pbw of water.

The particle spectrum determined by screen analysis gave the following weight distribution:

| | |
|---|---|
| above 1.6 mm: | 2% by weight |
| 1.6 to 0.8 mm: | 39% by weight |
| 0.8 to 0.4 mm: | 52% by weight |
| 0.2 to 0.1 mm: | 7% by weight |
| below 0 1 mm: | 0% by weight |

The bulk density was 563 g/l.

The spray tower powder prepared as in a) had the following composition:

tallow-fatty alcohol with 5 EO 2.1% by weight

zeolite NaA 67.4% by weight

water (bonded in the zeolite): 19.6%

acrylic acid-maleic acid copolymer (Na salt) 4.0% by weight

Na soap (C12-18-coconut-tallow soap 1:1) 2.5% by weight

sodium sulfate 4.4% by weight

b) Preparation of the solid nonionic surfactant/zeolite granulate

15.0 pbw of a nonionic surfactant (coconut alcohol+7 EO) heated to 50° C. were sprayed, in a mixer equipped with rotating mixing elements (spray mixer), onto 85.0 pbw of the spray-dried component over the course of 1.5 minutes, and the mixing was continued for a further 2 minutes. The mixture removed from the mixer and having a temperature of 33° C. was, after cooling to room temperature, readily flowable and had a bulk density of 700 g/l. The particle size distribution was virtually unchanged compared with the starting material.

The granulate prepared as in b) had the following composition:

coconut alcohol+7 EO: 15.0% by weight

tallow-fatty alcohol with 5 EO: 1.8% by weight

zeolite NaA: 57.1% by weight

water (bonded in the zeolite): 16.7%

acrylic acid-maleic acid copolymer (Na salt) 3.4% by weight

Na soap (C12-18-coconut-tallow soap 1:1) 2.2% by weight

sodium sulfate 3.8% by weight

c) Preparation of the granulate according to the invention with a core of solid nonionic surfactant/zeolite granulate and a shell of fatty alcohol sulfate

Feed materials:

A1) fatty alcohol sulfate in the form of the sodium salt, prepared from a C12/14-fatty alcohol mixture

A2) C12/C14-alkyl oligoglucoside with a DP of 1.5 (Glucopon 600)

A3) the solid nonionic surfactant/zeolite granulate prepared under b) with a particle size distribution of

| | |
|---|---|
| above 1.6 mm: | 2% by weight |
| 1.6 to 0.8 mm: | 39% by weight |
| 0.8 to 0.4 mm: | 52% by weight |
| 0.2 to 0.1 mm: | 7% by weight |
| below 0 1 mm: | 0% by weight |

and a bulk density of 700 g/l.

The surface-active feed materials A1) and A2) are commercial products from Cognis GmbH Germany, Dusseldorf

Preparation of the granulates in the fluidized bed(=SKET process):

The granulates were prepared in a continuously operating fluidized bed. In this process, aqueous surfactant pastes A1) and A2) were introduced simultaneously into the fluidized bed via nozzles. Separately to this, the nonionic surfactant/zeolite granulate A3) was metered in via an automatically regulated solids metered addition. The product streams of aqueous surfactant paste and added nonionic surfactant/zeolite granulate were controlled such that granulates with the desired composition by weight resulted. In the fluidized bed, the surfactant paste is sprayed onto the solid nonionic surfactant/zeolite granulate, thus coating it, with simultaneous drying-off of the water.

The surfactant granulates are considered to be dried if the content of free water is below 10% by weight, preferably from 0.5 to 5% by weight, in each case based on the finished granulates.

A fluidized bed apparatus with a base plate with a diameter of 2.5 m was used.

The granulates were discharged via a granulate size classification. This classification was carried out using a countercurrent stream of air (sifter air), which was regulated so that firstly particles above a certain particle size are removed from the fluidized bed and smaller particles are retained in the fluidized bed.

In the case of the process in the fluidized bed, it is necessary for a starting mass to be present at the start of the process. The starting mass initially introduced was 2 t of solid nonionic surfactant/zeolite granulate which serves as initial carrier for the sprayed-in surfactant pastes.

The surfactant granulates obtained from the fluidized bed were then cooled in a separate fluidized bed and classified using a screen into granulates with particle sizes between 0.2 and 1.6 mm as acceptable particle fraction, into granulates above 1.6 mm as oversize fraction and into granulates below 0.2 mm as undersize fraction. The granulates of the undersize fraction are returned to the fluidized bed. The oversize fraction is ground, preferably to particle sizes below 0.5 mm, and likewise returned to the fluidized bed.

Characteristic data of the process:

fluidized air speeds in m/s: 3.0 (under process conditions)

temperatures in ° C.: base air 170 sifter air 20 exit air 85

throughput: surfactant A1) in t/h: 0.5 t

throughput: surfactant A2) in t/h: 0.5 t

throughput: solid nonionic surfactant/zeolite granulate A3) in t/h: 1.5 t

starting mass(=zero filling) 2.0 t of nonionic surfactant/zeolite granulate

Paste temperature of A1) prior to nozzle introduction: 70° C.

Paste temperature of A2) prior to nozzle introduction: 60° C.

The resulting granulates were classified according to the particle size distribution:

| | |
|---|---|
| above 1.6 mm: | 5% by weight |
| 1.6 to 0.8 mm: | 65% by weight |
| 0.8 to 0.4 mm: | 25% by weight |
| 0.2 to 0.1 mm: | 5% by weight |
| below 0 1 mm: | 0% by weight |

The bulk density was 610 g/l.

The water content was 0.5% (not taking into consideration the water bonded to zeolite)

The fluidized bed granulate prepared as in c) had the following composition:

C 12/14-fatty alcohol sulfate: 14.5% by weight

C 12/C14-alkyl oligoglucoside: 12.2% by weight

coconut alcohol+7 EO: 11.0% by weight

tallow fatty alcohol with 5 EO 1.3% by weight

zeolite NaA 41.5% by weight

water (bonded in the zeolite): 12.1%

acrylic acid-maleic acid copolymer (Na salt) 2.5% by weight

Na soap (C12-18-coconut tallow soap 1:1) 1.6% by weight

sodium sulfate 2.8% by weight

free water: 0.5% by weight

d) Preparation of detergent tablets

The fluidized bed granulate prepared as in c) was mixed, by mixing with bleaches, bleach activator and further preparation components, to give the premix to be compressed, and thus a molding with the following composition was prepared:

fluidized bed granulate: 57.5% by weight

C 12-18 fatty alcohol sulfate (Sulfopon 1218 G): 7.0% by weight

(Sulfopon 1218 G is a commercial product from Cognis GmbH Germany, Dusseldorf)

sodium percarbonate: 20.0% by weight

TAED: 5.0% by weight

foam inhibitor: 3.5% by weight

enzymes: 1.5% by weight

perfume: 0.5% by weight

disintegration auxiliary (cellulose): 5.0% by weight

This mixture was then compressed in a Korsch eccentric press to give tablets (diameter: 44 mm, height: 22 mm, weight: 37.5 g).

### Comparative Example 1

A solid nonionic surfactant/granulate was prepared as described in example 1 under a).

As a deviation from example 1, this solid nonionic surfactant/granulate was not coated in a fluidized bed with C 12/14-fatty alcohol sulfate in the form of the sodium salt and C12/C14-alkyl oligoglucoside with a DP of 1.5 (Glucopon 600), but rather the premix to be compressed for the preparation of detergent tablets was prepared as follows:

solid nonionic surfactant/granulate: 42.3% by weight

dried C 12/14-fatty alcohol sulfate: 8.244.8% by weight

dried C12/C14-alkyl oligoglucoside: 7.0% by weight

C 12-18 fatty alcohol sulfate (Sulfopon 1218 G) 7.0% by weight

Sulfopon 1218 G is a commercial product from Cognis Germany GmbH, Dusseldorf

sodium percarbonate: 20.0% by weight

TAED: 5.0% by weight

foam inhibitor: 3.5% by weight

enzymes: 1.5% by weight

perfume: 0.5% by weight

disintegration auxiliary (cellulose): 5.0% by weight

This mixture was then compressed in a Korsch eccentric press to give tablets (diameter: 44 mm, height: 22 mm, weight: 37.5 g).

Solubility of the detergent tablets:

The detergent tablets prepared as in example 1 or comparative example 1 were introduced into a beaker each containing 500 ml of water and the time taken for the detergent tablets to disintegrate was measured. “Disintegration” means here that relatively large particles were no longer present in the aqueous phase after this time.

The detergent tablet prepared as in example 1 disintegrated in 30 seconds, and the tablet prepared as in comparative example 1 disintegrated only after 5 minutes.

1. A surfactant mixture in solid form, characterized in that it has a core and a shell, where the core comprises at least one nonionic surfactant and the shell comprises, as coating substance, at least one anionic surfactant or at least one nonionic surfactant not present in the core or at least one zwitterionic surfactant or a mixture of two or more of said surfactants.

2. The surfactant mixture as claimed in claim 1, characterized in that the core comprises, as nonionic surfactant, at least one alcohol ethoxylate or an ester ethoxylate having 2 to 30 ethylene oxide units or mixture thereof.

3. The surfactant mixture as claimed in claim 1 or 2, characterized in that the core comprises a carrier substance.

4. The surfactant mixture as claimed in any of claims 1 to 3, characterized in that the shell comprises, as coating substance, a sulfate or sulfonate.

5. The surfactant mixture as claimed in any of claims 1 to 4, characterized in that it comprises, as coating substance, at least one fatty alcohol sulfate.

6. The surfactant mixture as claimed in any of claims 1 to 5, characterized in that the shell has a solubility in water at 20° C. of at least 0.1 g/l.

7. A process for the preparation of solid surfactant mixtures, characterized in that a coating substance as claimed in claim 1 is deposited on a surfactant core which is in solid form and which comprises at least one nonionic surfactant, from an aqueous solution or melt, while the water evaporates.

8. The process as claimed in claim 7, characterized in that the deposition takes place by intimately mixing the surfactant core which is present in solid form with an aqueous solution or melt of the coating substance, and optionally removing water at the same time.

9. The process as claimed in claim 7, characterized in that the surfactant core which is present in solid form and an aqueous solution or melt of the coating substance are subjected to simultaneous drying and granulation in a fluidized bed.

10. A laundry detergent at least comprising one surfactant mixture as claimed in any of claims 1 to 6 or a surfactant mixture prepared as claimed in any of claims 7 to 9.

11. The laundry detergent as claimed in claim 10, characterized in that it is in the form of an extrudate, granulate or tablet.

12. The use of surfactant mixtures as claimed in any of claims 1 to 6 for the preparation of laundry detergents.
